(19) United States
(12) Patent Application Publication
(10) Pub. No.: US 2026/0122673 A1
(43) Pub. Date: Apr. 30, 2026

(54) METHODS AND APPARATUS OF CHANNEL OCCUPANCY TIME (COT) SHARING IN SIDELINK UNLICENSED COMMUNICATION SYSTEMS

(71) Applicant: MediaTek Singapore Pte. Ltd., Singapore (SG)

(72) Inventors: Junqiang CHENG, Beijing (CN); Tao CHEN, Beijing (CN); Min LEI, Beijing (CN)

(21) Appl. No.: 18/835,799

(22) PCT Filed: Feb. 10, 2023
(86) PCT No.: PCT/CN2023/075451

§ 371 Date: Aug. 5, 2024

(30) Foreign Application Priority Data
Feb. 11, 2022 (WO) PCT/CN2022/075989
Feb. 4, 2023 (CN) 202310111841.9

(51) Int. Cl. H04W 74/0808; H04W 72/40

(52) U.S. Cl. CPC H04W 74/0808; H04W 72/40

(57) ABSTRACT

Apparatus and methods are provided for COT sharing in sidelink unlicensed communication systems. In novel aspect, an COT initiating UE shares one or more SL resources within a COT to one or more responding UEs. In one embodiment, the responding UE is a target receiver of the COT initiating UE. In one embodiment the responding UE uses the shared resources for transmission that the COT initiating UE is one of the target receivers. In one embodiment, COT sharing information comprises COT time and frequency location information, shared COT starting offset information, remaining COT duration information, one or more resource block (RB) set(s) in the COT, channel access type, channel access priority type (CAPC) level, and ID information. In one embodiment, the COT sharing information is carried in a 1^{st}-stage SCI, a 2^{nd}-stage SCI, a combination of a 1^{st}-stage SCI and 2^{nd}-stage SCI, or a MAC-CE. In one embodiment, the responding UE performs an channel access before using the shared COT resource. The channel access type is (pre-) configured based on a transmission gap or indicated by the COT initiating UE.

### TECHNICAL FIELD

The disclosed embodiments relate generally to wireless communication, and, more particularly, to channel occupancy time (COT) sharing for sidelink communication on unlicensed spectrum.

### BACKGROUND

With the development and availability of 5G fast expanding worldwide, the demand of wireless data traffic is continually increasing, which in turn will require the availability of more spectrum to improve the capacity of future wireless communication systems. Therefore, the utilization of unlicensed spectrum including 2.4 GHz, 5 GHZ, and 60 GHz has drawn a lot of attention from both the academic and industry, which further motivates the successful development of LTE licensed assisted access (LAA) communication and 5G NR unlicensed (NR-U) communication in 3GPP. These unlicensed radio access technologies (RATs) can be regarded as an effective supplement to the licensed communications, and further alleviate the increasing demand of data traffic.

Sidelink is originally introduced as the device-to-device (D2D) communications in 3GPP Release 12 to enable direct transmissions between two devices without the data going through the network. Subsequently, sidelink technology is further extended to involve the scopes of LTE based vehicle-to-everything (V2X), and/or cellular V2X (C-V2X), and/or NR based V2X. The critical role and application of sidelink technology in LTE and NR have made it an inevitable remedy to support numerous use cases in the future wireless communication systems. Based on the above observations, for the development of beyond 5G (B5G) and future 6G communication technology, the research and design of sidelink communication on unlicensed spectrum (SL-U) is regarded as one of the most promising directions of the further sidelink enhancement and evolution.

For the communications on unlicensed frequency bands, the fair and harmonious coexistence among different RATs is considered as one of the most significant issues. Listen before talk/transmission (LBT) is a way to access the unlicensed channel for a period, which is referred to as the channel occupancy time (COT). The UE that initiated the COT can reserve resources in the COT. To further improve the efficiency of the system, the initiating UE should be able to share the reserved resource in the COT to other UEs.

Improvements and enhancements are required for sidelink resource sharing in unlicensed frequency bands.

### SUMMARY

Apparatus and methods are provided for COT sharing in sidelink unlicensed communication systems. In novel aspect, a UE performs an LBT/channel access, initiates a COT upon success of the COT, wherein a plurality of SL resources are (pre-) configured within the COT, and shares one or more SL resources within the COT to one or more responding UEs based on one or more COT sharing rules. In one embodiment, the SL resources are shared to a responding UE that is a target receiver of a first SL transceiving from the COT initiating UE, and wherein the first SL transceiving from the COT initiating UE uses at least one SL resource within the COT, or the responding UE that uses the one or more SL resources for a second SL transceiving, and wherein the COT initiating UE is a receiver of the second SL transceiving. In another embodiment, the SL resources are a responding UE that uses the one or more SL resources to communicate with one or more other UEs. In one embodiment, COT sharing information are sent to the one or more responding UEs. The COT sharing information are (pre-) configured to include one or more COT elements about the SL resources to be shared comprising COT time and frequency location information, shared COT starting offset information, remaining COT duration information, one or more resource block (RB) set(s) in the COT, channel access type, channel access priority type (CAPC) level, and ID information. In one embodiment, the COT sharing information is carried in a first stage sidelink channel information (SCI), a second stage SCI, a combination of a first stage SCI and a second stage SCI, or a MAC-CE. In one embodiment, the responding UE performs a channel access before using the shared COT resource. The channel access type is (pre-) configured based on a transmission gap that is between a SL resource for transmission by the initiating UE and a starting position the one or more shared SL resources to be used by the responding UE, or based on a transmission gap that is between a starting position of one or more shared SL resources to be used by one responding UE and a starting position of the one or more shared SL resources to be used by another responding UE. In one embodiment, a type 2A channel access is (pre-) configured if the transmission gap is greater than or equal to a first gap threshold, a type 2C channel access is (pre-) configured if the transmission gap is smaller than or equal to a second gap threshold, otherwise a type 2B channel access is (pre-) configured, and wherein the first gap threshold is greater than the second gap threshold. In one embodiment, the channel access type is indicated by the COT initiating UE via COT sharing information.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a schematic system diagram illustrating an exemplary wireless network for COT sharing in sidelink data communication in unlicensed frequency bands in accordance with embodiments of the current invention.

FIG. 2A illustrates exemplary diagrams of COT sharing with a responding UE where the shared resources are used to communicate with the initiating UE in accordance with embodiments of the current inventions.

FIG. 2B illustrates exemplary diagrams of COT sharing with a responding UE where the shared resources are used to communicate with other UEs in accordance with embodiments of the current inventions.

FIG. 3A illustrates a power control scheme based on the pathloss between the initiating device and the responding device, where the responding device is far away from the initiating device in the case that the shared COT is used by the responding device to communicate with other devices in the group in accordance with embodiments of the current invention.

FIG. 3B illustrates a power control scheme based on the pathloss between the initiating device and the responding device, where the responding device is near the initiating device in the case that the shared COT is used by the responding device to communicate with other devices in the group in accordance with embodiments of the current invention.

FIG. 3C illustrates a power control scheme based on the pathloss between the responding device and the other devices in the case that the shared COT is used by the responding device to communicate with other devices in the group in accordance with embodiments of the current invention.

FIG. 4A illustrates an exemplary of COT sharing information carried in the 1^{st}-stage SCI with new format/PSCCH in accordance with embodiments of the current invention.

FIG. 4B illustrates an exemplary of COT sharing information carried in the 2^{nd}-stage SCI/PSSCH in accordance with embodiments of the current invention.

FIG. 4C illustrates an exemplary of COT sharing signals/channels design with a combination of the 1^{st}-stage SCI and the 2^{nd}-stage SCI in accordance with embodiments of the current invention.

FIG. 5 illustrates an exemplary of the channel access type determination according to the transmission gap at the responding device side in accordance with embodiments of the current invention.

FIG. 6A illustrates an exemplary of the scheduling information carried in the 2^{nd}-stage SCI/PSSCH in accordance with embodiments of the current invention.

FIG. 6B illustrates exemplary diagrams of the scheduling information carried in the 2^{nd}-stage SCI/PSSCH and/or 1^{st}-stage SCI in accordance with embodiments of the current invention.

FIG. 7 illustrates an exemplary flow chart for the initiating UE for COT sharing in SL unlicensed communication system in accordance with embodiments of the current invention.

FIG. 8 illustrates an exemplary flow chart for the responding UE for COT sharing in SL unlicensed communication system in accordance with embodiments of the current invention.

### DETAILED DESCRIPTION

Reference will now be made in detail to some embodiments of the invention, examples of which are illustrated in the accompanying drawings.

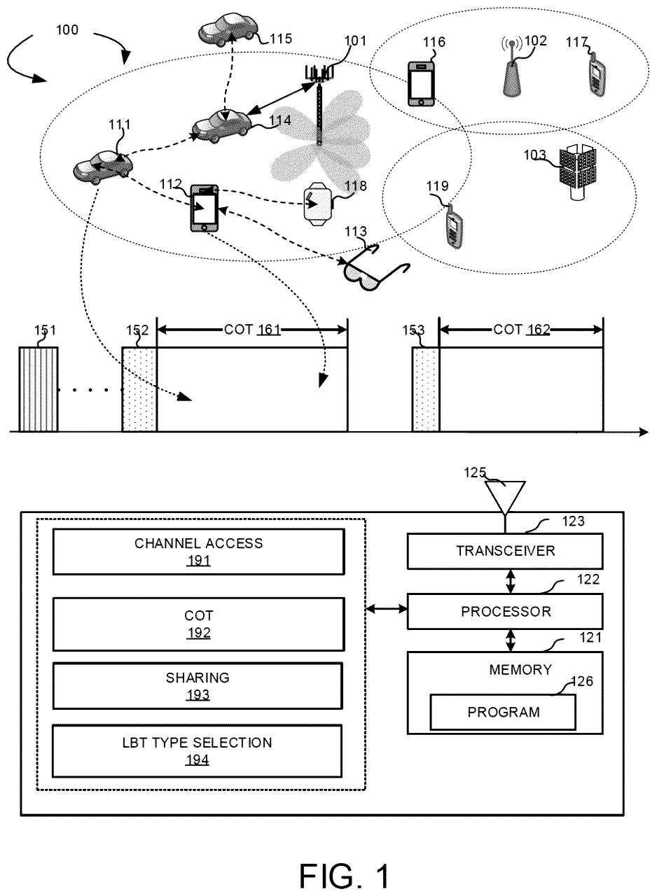

FIG. 1 illustrates a schematic system diagram illustrating an exemplary wireless network for COT sharing in sidelink data communication in unlicensed frequency bands in accordance with embodiments of the current invention. Wireless network 100 includes multiple communication devices or mobile stations, such as user equipments (UEs) 111, 112, 113, 114, and 115, which are configured with sidelink in unlicensed frequency bands. The exemplary mobile devices in wireless network 100 have sidelink capabilities. Sidelink communications refer to the direct communications between terminal nodes or UEs without the data going through the network. For example, UE 112 communicates with UE 118 directly without going through links with the network units. The scope of sidelink transmission also supports UE-to-network relay to extend the service range of an eNB, where the inter-coverage UE acts as the relay node between an eNB and an out-of-coverage UE. For example, UE 114 is connected with base station 101 through an access link. UE 114 provides network access for out-of-coverage UE 115 through sidelink relay. The base station, such as base station 101, may also be referred to as an access point, an access terminal, a base station, a Node-B, an eNode-B (eNB), a gNB, or by other terminology used in the art. The network can be a homogeneous network or heterogeneous network, which can be deployed with the same frequency or different frequencies. Base station 101 is an exemplary base station. With the demands for more capacity and the development of sidelink communication, it is important for the sidelink devices to use the unlicensed frequency bands and be harmoniously coexistence with devices with other RATs operating in the same unlicensed frequency bands. For example, neighboring UEs 116 and 117 communicate with base station 102 through other RATs, such as Wi-Fi, sharing the same unlicensed frequency band. Neighboring UE 119 communicate with base station 103 through other RATs, such as NR, sharing the same unlicensed frequency band.

For sidelink transmissions on the unlicensed spectrum (SL-U), efficient resource allocation is one of the most critical issues to ensure the fair coexistence with other RATs operated in the unlicensed spectrum, such as NR-U and Wi-Fi, etc. Two modes of resource allocation schemes are identified for NR sidelink. The first one is named Mode-1, while the second is Mode-2. For Mode-1, the resource allocation is scheduled by the gNB using the Uu interface. This mode is only suitable for the sidelink UEs in network coverage. For Mode-2, the sidelink UE can autonomously select the resources from a (pre-) configured resource pool(s) based on the channel sensing mechanism over PC5 interface. In this case, the sidelink UEs can operate both under in-coverage and out-of-coverage. When a transmitting sidelink UE attempts to select/reserve resources with Mode-2, it should conduct the resource selection/reservation procedures, which include two stages: resource sensing and resource selection/reservation. Generally, in the resource sensing stage, to avoid causing interference to the existing sidelink transmissions operated by other sidelink UEs, the candidate resources potentially available for the sidelink transceiving are identified. Next, in the resource selection stage, the sidelink UE can select the candidate resources used for transmission block (TB) transmission with the assistance of the sensing results. In one novel aspect, listen before talk (LBT) is used in the selection stage for the unlicensed frequency bands resources. LBT is a spectrum sharing technology by which a device must perform the clear channel assessment (CCA) check before it starts a transmission. Empowered by the LBT mechanism, it is possible for multiple UEs to share a channel, and fair coexistence among different RATs can be guaranteed.

To ensure the fair and harmonious coexistence among different RAT in the unlicensed bands, the LBT is performed before an SL device/UE can access the SL resources in the unlicensed channels. As an example, at step 151, an LBT is performed and failed. No SL transceiving was performed when LBT was failed. At step 152, UE 111 performs LBT, which is successful. Upon the success of LBT, UE 111 initiates COT 161. In one novel aspect, the initiating UE 111 may share the resources within COT 161 with one or more responding UEs, 10 such as UE 112. UE 111 may initiate another COT 162 upon success of LBT at step 153.

FIG. 1 further illustrates simplified block diagrams of a mobile device/UE for operating in the unlicensed frequency band. UE 111 is an example. UE 111 has an antenna 125, which transmits and receives radio signals. An RF transceiver circuit 123, coupled with the antenna, receives RF signals from antenna 125, converts them to baseband signals, and sends them to processor 122. In one embodiment, the RF transceiver may comprise two RF modules (not shown). RF transceiver 123 also converts received baseband signals from processor 122, converts them to RF signals, and sends out to antenna 125. Processor 122 processes the received baseband signals and invokes different functional modules to perform features in UE 111. Memory 121 stores program instructions and data 126 to control the operations of UE 111. Antenna 125 sends uplink transmission and receives downlink transmissions to/from base stations.

UE 111 also includes a set of control modules that carry out functional tasks. These control modules can be implemented by circuits, software, firmware, or a combination of them. A channel access module 191 performs an LBT procedure to prepare for a UE sidelink (SL) transceiving in unlicensed frequency bands in a wireless network, wherein the LBT procedure determines channel selection with other coexisting wireless system in the unlicensed frequency bands. A COT module 192 initiates a COT upon success of the LBT, wherein a plurality of SL resources are configured within the COT. A sharing module 193 shares one or more SL resources within the COT to one or more responding UEs based on one or more SL COT sharing rules. A LBT type selection module 194 selects an LBT type based on a transmission gap that is between a SL resource for transmission by the initiating UE and a starting position of the one or more shared SL resources to be used by the responding UE and transceives packets using the one or more shared SL resources upon success of the channel access.

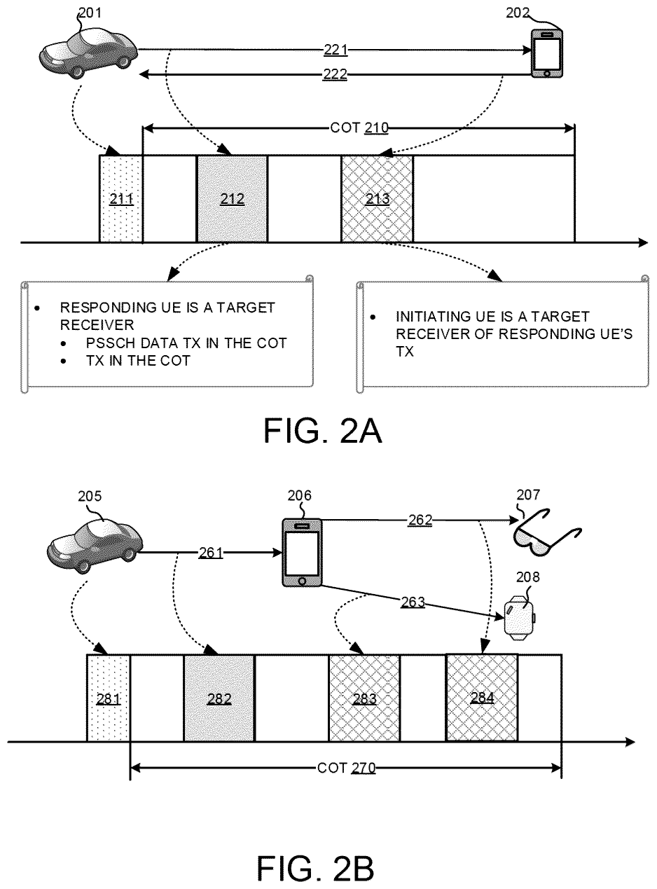

FIG. 2A illustrates exemplary diagrams of COT sharing with a responding UE where the shared resources are used to communicate with the initiating UE in accordance with embodiments of the current inventions. UE 201 and UE 202 are exemplary UEs that are configured with SL and operate in the unlicensed frequency band. UE 201 performs an LBT 211 successfully. COT 210 is initiated. UE 201 can configure and use candidate resources within COT 210. In one novel aspect, the initiating UE shares one or more SL resources within COT 210 to one or more responding UEs, such as UE 202, based on one or more SL COT sharing rules. In one embodiment, the COT sharing rule requires the COT resources be shared to a responding UE that is a target receiver of SL transceiving 221 from the initiating UE and the SL transceiving uses at least one SL resource, such as resource 212, within COT 210. In one example, UE 202 uses the shared COT resource 212 to transmit acknowledgement (ACK) or negative acknowledgement (NACK) if a physical sidelink feedback channel (PSFCH) is (pre-) configured. In another example, UE 202 uses shared COT resource 212 to transmit traffic on a physical sidelink control channel (PSCCH)/physical sidelink shared channel (PSSCH). In another example, UE 202 uses shared COT resource 212 to transmit sidelink synchronization signal block (S-SSB). In one embodiment, UE 202 uses the shared COT resource 212 for SL transmission to UE 201, the COT initiating UE. In another embodiment, one or more SL resources, such as shared COT resource 213, are shared to a responding UE, such as UE 202, that uses the one or more SL resources for a SL transceiving, such as SL transceiving 222, wherein the initiating UE 201 is a receiver of the transceiving 222. In this case, UE 201, the COT initiating UE may be one of many target receivers of SL transmission 222 from UE 202, which uses the shared COT resource 213.

FIG. 2B illustrates exemplary diagrams of COT sharing with a responding UE where the shared resources are used to communicate with other UEs in accordance with embodiments of the current inventions. UE 205, UE 206, UE 207, and UE 208 are exemplary UEs that are configured with SL and operate in the unlicensed frequency band. UE 205 performs LBT 281 successfully. COT 270 is initiated. UE 205 can configure and use candidate resources within COT 270. In one novel aspect, the initiating UE 205 shares one or more SL resources within COT 270 to one or more responding UEs, such as UE 206, based on one or more SL COT sharing rules. In one example, UE 205 can share COT resource 282 with responding UE 206, which uses COT resource 282 for communication 261 with initiating UE 205. In one embodiment, one or more SL resources, such as shared COT resource 283 and shared COT resource 284, are shared to a responding UE, such as UE 206 that uses the one or more SL resources to communicate with other UEs, such as UE 207 and UE 208. In one example, shared COT resource 283 is used for communication 263 between the responding UE 206 and another UE 207. In another example, shared COT resource 284 is used for communication 262 between the responding UE 206 and another UE 208.

In one embodiment, the SL COT sharing rule includes to enable power control, the transmission power of the scheduling UE can be indicated via COT info or scheduling grant for the scheduled UE to derive the pathloss for power control. The power control is (pre-) configured to use the pathloss between the COT initiating UE and the responding UE or between the responding UE and one or more other UEs with the consideration of PSD requirement of unlicensed spectrum.

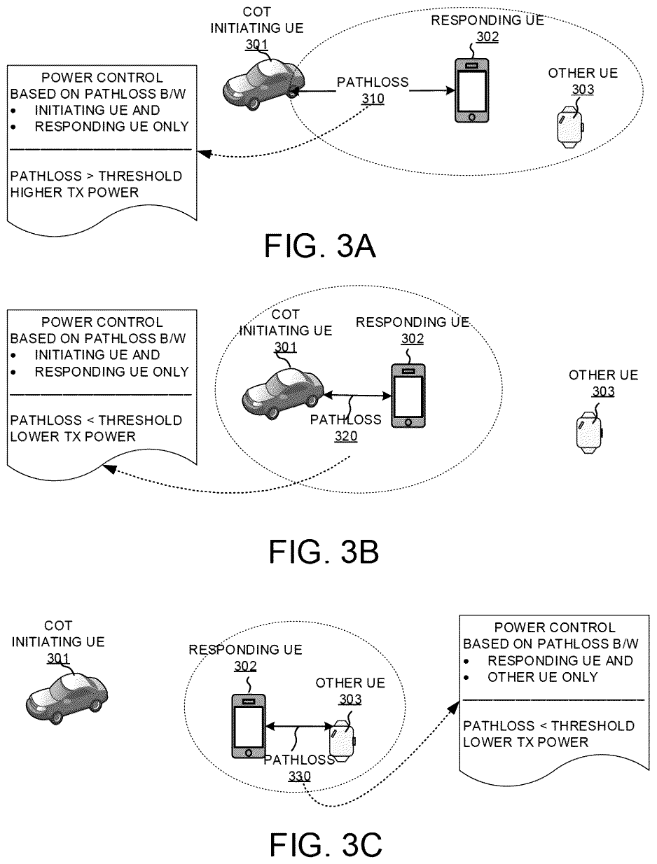

FIG. 3A illustrates a power control scheme based on the pathloss between the initiating device and the responding device, where the responding device is far away from the initiating device in the case that the shared COT resources is used by the responding device to communicate with other devices in the group. UE 301 is an initiating UE, which shares one or more COT resources with responding UE 302. In one embodiment, responding UE 302 uses one or more the shared COT resources to communicate with another UE 303. In one embodiment, when using the shared COT resource for transmission, the power control of responding UE 302 is further based on the pathloss 310 of COT initiating UE 301 and responding UE 302 only. In one example, when pathloss 310 between COT initiating UE 301 and responding UE 302 is greater than a (pre-) defined/(pre-) configured threshold, responding UE 302 may raise its transmitting power based on pathloss 310. Responding UE 302 using the shared COT resource shared by COT initiating UE 301 transmits at a higher transmitting power when UE 302 is farther from COT initiating UE 301 than when UE 302 is closer to UE 301.

FIG. 3B illustrates a power control scheme based on the pathloss between the initiating device and the responding device, where the responding device is near the initiating device in the case that the shared COT resources is used by the responding device to communicate with other devices in the group. UE 301 is an initiating UE, which shares one or more COT resources with responding UE 302. In one embodiment, responding UE 302 uses one or more the shared COT resources to communicate with another UE 303. In one embodiment, when using the shared COT resource for transmission, the power control of responding UE 302 is further based on the pathloss 320 of COT initiating UE 301 and responding UE 302 only. In one example, when pathloss 320 between COT initiating UE 301 and responding UE 302 is smaller than a predefined/preconfigured threshold, responding UE 302 may lower its transmitting power based on pathloss 320. Responding UE 302 using the shared COT resource shared by COT initiating UE 301 transmits at a lower transmitting power when UE 302 is closer to COT initiating UE 301 than when UE 302 is farther away from UE 301.

FIG. 3C illustrates a power control scheme based on the pathloss between the responding device and the other devices in the case that the shared COT resources is used by the responding device to communicate with other devices in the group. UE 301 is an initiating UE, which shares one or more COT resources with responding UE 302. In one embodiment, responding UE 302 uses one or more the shared COT resources to communicate with another UE 303. In one embodiment, when using the shared COT resource for transmission, the power control of responding UE 302 is further based on the pathloss 330 of responding UE 302 and other UE 303 only. Responding UE 302 obtains an estimation of the pathloss 330 from the feedback of the received signal reference power (RSRP) measured at the other device side, such as UE 303. In one example, when pathloss 330 between responding UE 302 and other UE 303 is smaller than a predefined/preconfigured threshold, responding UE 302 may lower its transmitting power based on pathloss 330. Similarly, when pathloss 330 is larger than a predefined/preconfigured threshold (not shown), responding UE 302 may raise its transmitting power based on pathloss 330.

In another embodiment, the power control can be configured to use both the pathloss between the initiating device and the responding device, and the pathloss between the responding device and the other devices. In this case, a damping factor can be configured to adjust the contributions of the two pathloss types to the total power control. The responding device needs to measure the reference signals sent by the initiating device to drive the pathloss between the initiating device and the responding device. Besides, the responding device also needs the feedback of the RSRP measured at the other device side to drive the pathloss between the responding device and the other device.

After the COT is initiated, the initiating device should deliver the COT sharing information or channel occupancy indicator (COI) to the other devices in the group. The COT sharing information includes one or more COT elements comprising COT time and frequency location information, shared COT starting offset information, remaining COT duration information, one or more resource block (RB) set(s) in the COT, channel access type, channel access priority type (CAPC) level, and ID information. The COT sharing information may be carried in different channels.

In other embodiments, COT information, which may be the sharing information, the scheduling information, or a combination of both, can carry information about the starting offset, COT duration, configuration for the behavior within the COT (e.g., channel access type, ID indication, etc.), the slot/resource configuration within the COT, including slot/resource for the scheduling UE and/or COT initiating UE. It may also include the slot/resource for the scheduled UEs (and/or COT sharing UEs), PSFCH time/frequency resource allocation within the COT. For the indication of the slot/resource configuration within the COT, the bitmap can be used to indicate each slot (w/one or two bits in the bitmap) within the COT duration is reserved for scheduling UE (and/or COT initiated UE) or the scheduled UEs (and/or COT sharing UEs). The flexible slot may be supported via the indication in the bitmap. The flexible slot can be further indicated by a SCI or derived by the time relation (e.g., scheduling PSCCH/PSSCH-PSFCH A/N timing, scheduling PSCCH-scheduled PSSCH timing) to determine/overwrite the slot for transmission of the scheduling UE (and/or COT initiated UE) or for transmission of scheduled UE (and/or COT sharing UE). In one embodiment, to enable power control, the transmission power of the scheduling UE can be indicated via COT info or scheduling grant for the scheduled UE to derive the pathloss for power control.

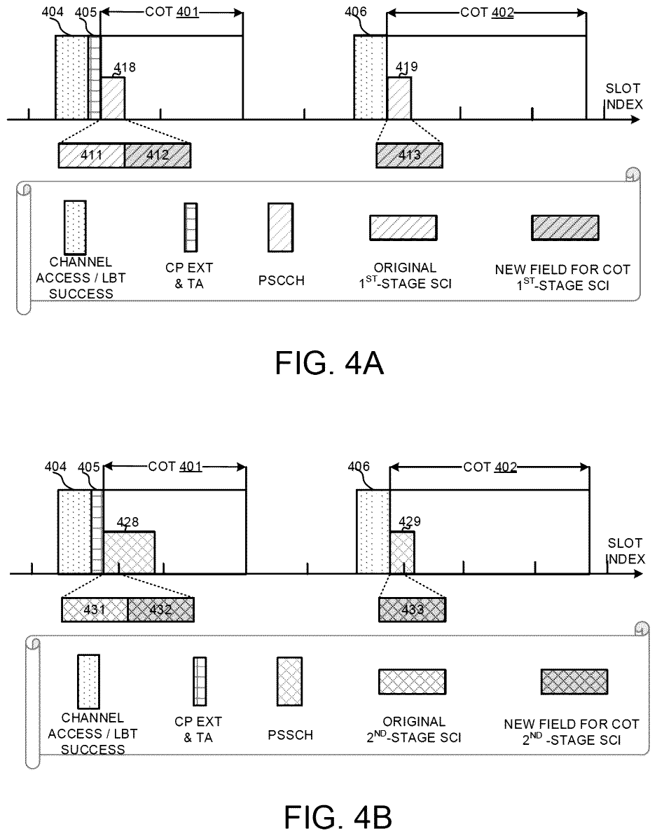

FIG. 4A illustrates an exemplary of COT sharing signals/channels/COT sharing information container design where the COT sharing signals/channels are carried in the 1^{st}-stage sidelink control information (SCI) with new format/physical sidelink control channel (PSCCH) in accordance with embodiments of the current invention. In one embodiment, the COT sharing signals/channels can be carried in the 1^{st}-stage SCI/PSCCH with a new format where both the information of the original sidelink 1^{st}-stage SCI and the information of COT are included. Alternatively, the COT sharing signals/channels can be carried in 1^{st}-stage SCI with a new format/PSCCH, where only the information of COT is included.

The initiating UE performs a successful LBT 404, which initiating CTO 401. CP extension & TA 405 is performed before the starting of COT 401. In one embodiment, COT sharing information is carried by PSCCH channel 418 with the 1^{st}-stage SCI with a new format. In one embodiment, both the original 1^{st}-stage SCI information 411 and the COT sharing information 412 is carried in PSCCH 418. In another embodiment, after a successful LBT 406, COT 402 is initiated. PSCCH 419 carries the COT sharing information with 1^{st}-stage SCI with a new formation. In one embodiment, only COT sharing information 413 is included in PSCCH 419. Both approaches can be applied depending on whether both the legacy 1^{st}-stage SCI and COT info are multiplexed for transmission together. For example, for the transmission of COT info in the beginning of the slot overlapping with 1^{st}-stage SCI, the new 1^{st}-stage SCI format can be introduced to include both COT info and the original 1^{st}-stage SCI contents. For the transmission of the COT info in the other symbols of the slot not overlapping with 1^{st}-stage SCI transmission, the independent SCI format can be applied to mainly include COT-only info (w/o need of sensing info in 1^{st}-stage SCI). In this scheme, the responding devices in the group can be configured to monitor the 1^{st}-stage SCI per symbol. If the responding devices detect the 1^{st}-stage SCI at the staring position of a slot, it can obtain the information such as sidelink traffic priority, the resource reservation period, the reserved resources position, etc., and also the COT information if the COT is initiated at the slot starting position. If the responding devices detect the 1^{st}-stage SCI at a position within the slot other than the starting position, it can obtain the COT information. For this scheme, the responding devices can be configured to monitor 1^{st}-stage SCI only to obtain the COT information, but if there is no initiated COT, or the COT is not initiated at the starting position of the slot, there may be a waste for the bits reserved for the COT information in the 1^{st}-stage SCI.

FIG. 4B illustrates an exemplary of COT sharing signals/channels design where the COT sharing signals/channels is carried in the 2^{nd}-stage SCI/PSSCH in accordance with embodiments of the current invention. The initiating UE performs a successful LBT 404, which initiating CTO 401. CP extension & TA 405 is performed before the starting of COT 401. In one embodiment, 2^{nd}-stage SCI/PSSCH is used to carry the COT sharing information. In one embodiment, the 2^{nd}-stage SCI should be configured so that all the responding devices in the group can decode it to obtain the COT information. A 2^{nd}-stage SCI is carried by physical sidelink shared channel (PSSCH) 428. In one embodiment, both the original 2^{nd}-stage SCI information 431 and the COT sharing information 432 is carried in PSSCH 428. In another embodiment, after a successful LBT 406, COT 402 is initiated. PSSCH 429 carries the COT sharing information with 2^{nd}-stage SCI with a new formation. In one embodiment, only COT sharing information 433 is included in PSSCH 429. In this scheme, the responding devices in the group can be configured to monitor the 2^{nd}-stage SCI per symbol. If the responding devices detect the 2^{nd}-stage SCI, it can obtain the information such as HAQR process ID, the source ID, the destination ID, etc., and also the COT information if there is an initiated COT. For this scheme, the responding devices can be configured to monitor 2^{nd}-stage SCI only, but for the 2^{nd}-stage SCI without COT information, there may be a waste for the bits reserved for the COT information.

FIG. 4C illustrates an exemplary of COT sharing signals/channels design with a combination of the 1^{st}-stage SCI and the 2^{nd}-stage SCI in accordance with embodiments of the current invention. In one embodiment, the UE is carried with the COT sharing rule that the COT sharing signals/channels is carried in the 2^{nd}-stage SCI/PSSCH if the COT is initiated at the starting position of the slot, and is carried in the 1^{st}-stage SCI with new format/PSCCH if the COT is not initiated at the starting position of the slot.

In one embodiment, the COT sharing signals/channels can be carried in both the 1^{st}-stage SCI/PSCCH and the 2^{nd}-stage SCI/PSSCH. If the COT is initiated at the starting position of the slot, the COT information can be carried on the 2^{nd}-stage SCI, where the information of the original 2^{nd}-stage SCI and the information of COT are both included. If the COT is not initiated at the starting position of the slot, the COT information can be carried on the 1^{st}-stage SCI with a new format, where only the information of COT is included. For example, the initiating UE performs a successful LBT 406, and COT 402 is initiated. The COT information is included in a PSCCH 459 with COT sharing information 465. In this scheme, one new bit 466 is added to the original sidelink 1^{st}-stage SCI at the slot starting position. This new bit is used to indicate whether the COT information is carried on the 1^{st}-stage SCI with new format, or the 2^{nd}-stage SCI as mentioned above. If the COT is initiated at the starting position of the slot, the COT sharing information 467 can be carried in the 1^{st}-stage SCI with PSCCH 458. For this scheme, the responding devices can be configured to monitor the COT sharing signals/channels per symbol.

In another embodiment, if the COT is initiated at the starting position of the slot, the new added bit in the original 1^{st}-stage SCI is configured to, for example, ‘0’, which indicates the COT sharing signal/channel is the 2^{nd}-stage SCI, and the responding device should decode the 2^{nd}-stage SCI to obtain the COT information. For example, the initiating UE performs successful LBT 404 and CP extension & TA 405 is performed before the start of COT 401. A 1^{st}-stage SCI carried by PSCCH 456 includes the original 1^{st}-stage SCI 461 and one bit ‘0’ 462 indicating 2^{nd}-stage SCI 455 carried by PSSCH 454 contains COT sharing information. 2^{nd}-stage SCI 455 includes original 2^{nd}-stage SCI 464 and COT sharing information 463. If the COT is not initiated at the starting position of the slot, the new added bit in the original 1^{st}-stage SCI is configured to, for example, ‘1’, which indicates the COT sharing signal/channel is the 1^{st}-stage SCI with a new format. For example, PSCCH 459 in COT 402 carries original 1^{st}-stage SCI 465 and a bit ‘1’ 466 indicating COT sharing information is the 1^{st}-stage SCI with a new format. For this case, the responding device can obtain the COT information by decoding the new 1^{st}-stage SCI within the slot. In this scheme, no matter the COT is initiated at the starting position of the slot or not, only one new bit is added to the original 1^{st}-stage SCI at the slot starting position, which is more efficient compared to the other two schemes described previously.

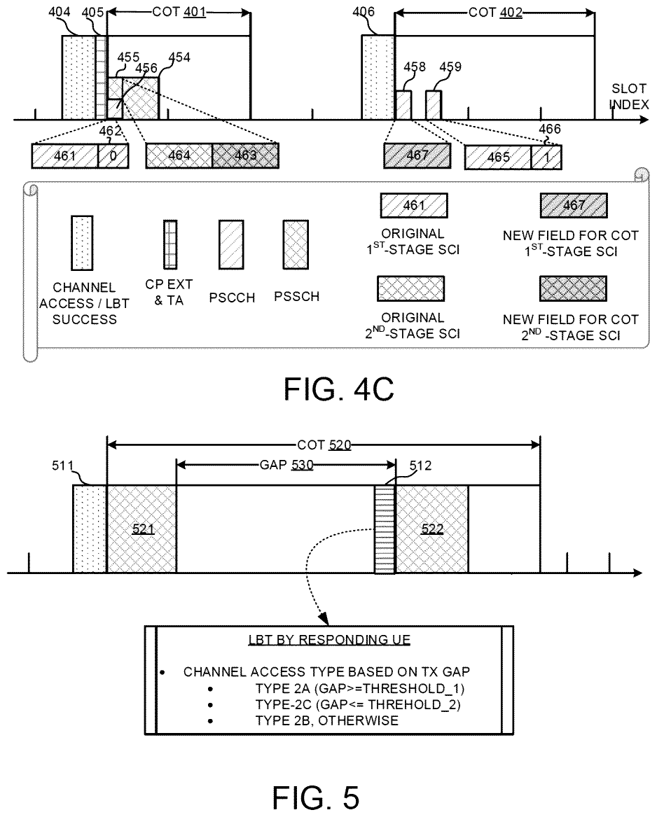

FIG. 5 illustrates an exemplary of the channel access type determination according to the transmission gap at the responding device side in accordance with embodiments of the current invention. The initiating UE performs a successful LBT 511. COT 520 is initiated. Resource 521 within the COT is used by the initiating UE and resource 522 is shared to a responding UE. A gap 530 exists between resource 521 and 522. In one embodiment, the responding UE receives sharing information from the initiating UE to prepare for a UE sidelink (SL) transceiving in unlicensed frequency bands in a wireless network, wherein the COT sharing information indicates one or more shared SL resources within a COT that is initiated by the initiating UE, performs a LBT 512 before transceiving SL packets using the one or more shared SL resources indicated in the COT sharing information, such as resource 522. After the COT sharing information is delivered to the responding devices in the group, the information of the COT location and the (remaining) COT duration can be obtained. Then before accessing the COT, SL-U devices should perform channel access mechanisms to ensure that the (remaining) COT is still available. The channel access type (LBT type) can be configured from Type 1 channel access, Type 2A channel access, Type 2B channel access and Type 2C channel access. In one embodiment, the LBT type is configured for the LBT to be performed by the responding UE based on a transmission gap 530 that is between a SL resource for transmission by the initiating UE and a starting position of the one or more shared SL resources to be used by the responding UE. In one embodiment, a type 2A channel access is configured if the transmission gap is greater than or equal to a first gap threshold, a type 2C channel access is configured if the transmission gap is smaller than or equal to a second gap threshold, otherwise a type 2B channel access is configured, and wherein the first gap threshold is greater than the second gap threshold. For example, if the gap 530 is up to 16 μs, the responding device can transmit the traffic on the shared COT after performing Type 2C channel access procedures. If the gap 530 is (at least) 25 μs or 16 μs, the responding device can transmit the traffic on the shared COT after performing Type 2A channel access or Type 2B channel access procedures, respectively.

In one embodiment, the channel access type performed by the responding device can be scheduled/indicated by the initiating device. In this scheme, the scheduling/COT information can be configured to include channel access type, CP extension configuration, ID information, and also the CAPC configuration, etc. In one embodiment, the scheduling/COT information is part of the COT sharing information.

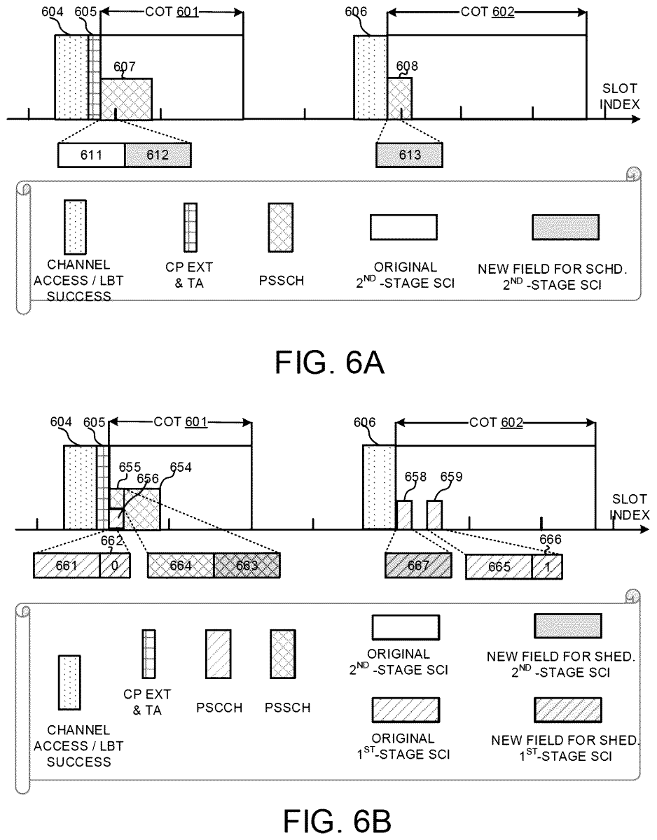

FIG. 6A illustrates an exemplary of the scheduling signals/channels design where the scheduling signals/channels is carried in the 2^{nd}-stage SCI/PSSCH no matter the scheduling information is transmitted at the starting position of the slot or not in accordance with embodiments of the current invention. The initiating UE performs a successful LBT 604, which initiating CTO 601. CP extension & TA 605 is performed before the starting of COT 601. In one embodiment, 2^{nd}-stage SCI/PSSCH is used to carry the COT scheduling information. In one embodiment, the 2^{nd}-stage SCI should be configured so that all the responding devices in the group can decode it to obtain the COT information. A 2^{nd}-stage SCI is carried by physical sidelink shared channel (PSSCH) 607. In one embodiment, both the original 2^{nd}-stage SCI information 611 and the scheduling information 612 are carried in PSSCH 607. In another embodiment, after a successful LBT 606, COT 602 is initiated. PSSCH 608 carries the scheduling information with 2^{nd}-stage SCI with a new formation. In one embodiment, only COT sharing information 613 is included in PSSCH 608. In this scheme, the responding devices in the group can be configured to monitor the 2^{nd}-stage SCI per symbol. If the responding devices detect the 2^{nd}-stage SCI, it can obtain the information such as HAQR process ID, the source ID, the destination ID, etc., and also the scheduling information if there is an initiated COT.

FIG. 6B illustrates exemplary diagrams of the scheduling signals/channels design where the scheduling signals/channels is carried in the 2^{nd}-stage SCI/PSSCH if the scheduling information is transmitted at the starting position of the slot and is carried in the 1^{st}-stage SCI with new format/PSCCH if the scheduling information is not transmitted at the starting position of the slot in accordance with embodiments of the current invention. In one embodiment, the scheduling signals/channels can be carried in both the 1^{st}-stage SIC/PSCCH and the 2^{nd}-stage SCI/PSSCH. If the COT is initiated at the starting position of the slot, the scheduling information can be carried on the 2^{nd}-stage SCI, where the information of the original 2^{nd}-stage SCI and the information of COT are both included. If the COT is not initiated at the starting position of the slot, the scheduling information can be carried on the 1^{st}-stage SCI with a new format, where only the information of COT is included. For example, the initiating UE performs a successful LBT 606, and COT 602 is initiated. The scheduling information is included in a PSCCH 659 with scheduling information 665. In this scheme, one new bit 666 is added to the original sidelink 1^{st}-stage SCI at the slot starting position. This new bit is used to indicate whether the COT information is carried on the 1^{st}-stage SCI with new format, or the 2^{nd}-stage SCI as mentioned above. If the COT is initiated at the starting position of the slot, the scheduling information 667 can be carried in the 1^{st}-stage SCI with PSCCH 658. For this scheme, the responding devices can be configured to monitor the scheduling signals/channels per symbol.

In another embodiment, if the COT is initiated at the starting position of the slot, the new added bit in the original 1^{st}-stage SCI is configured to, for example, ‘0’, which indicates the scheduling signal/channel is the 2^{nd}-stage SCI, and the responding device should decode the 2^{nd}-stage SCI to obtain the COT information. For example, the initiating UE performs successful LBT 604 and CP extension & TA 605 is performed before the start of COT 601. A 1^{st}-stage SCI carried by PSCCH 656 includes the original 1^{st}-stage SCI 661 and one bit ‘0’ 662 indicating 2^{nd}-stage SCI 655 carried by PSSCH 654 contains scheduling information. 2^{nd}-stage SCI 655 includes original 2^{nd}-stage SCI 664 and scheduling information 663. If the COT is not initiated at the starting position of the slot, the new added bit in the original 1^{st}-stage SCI is configured to, for example, ‘1’, which indicates the scheduling signal/channel is the 1^{st}-stage SCI with a new format. For example, PSCCH 659 in COT 602 carries original 1^{st}-stage SCI 665 and a bit ‘1’ 666 indicating scheduling information is the 1^{st}-stage SCI with a new format. For this case, the responding device can obtain the scheduling information by decoding the new 1^{st}-stage SCI within the slot. In this scheme, no matter the COT is initiated at the starting position of the slot or not, only one new bit is added to the original 1^{st}-stage SCI at the slot starting position, which is more efficient compared to the other two schemes described previously.

The sub-channel size can be set as 20 Mhz to be aligned with the resource block (RB) set of the other RAT (like WIFI) for co-existence. Additionally, the sub-channel size can be set smaller than 20 MHz (i.e., one resource block set is comprising of multiple sub-channels). The 1st SCI transmission/PSCCH of one UE can be fixed or (pre-) configured in one sub-channel (e.g., the first/lowest sub-channel of lowest RB set, or every RB set of corresponding PSSCH). It can avoid blind detection at SL-U UE supposing the UE will typically occupy one or multiple resource block set(s) in the unlicensed spectrum. Within a COT, multiple UEs can start transmission simultaneously via scheduling or (pre-) configuration. In this case, the SCI may not need to be transmitted for the scheduled UE. For the scheduling UE, the scheduling grant to schedule multiple UEs can be sent via single SCI and/or MAC-CE to include multiple scheduling info (or preferred resource info) corresponding to the multiple UEs. In this case, a bit map can be used to indicate which UE is scheduled and the corresponding field in (2nd) SCI and/or MAC-CE will be used to further indicate the scheduling info (or preferred resource info) of each scheduled UE. To differentiate with the existing SCI format, the new SCI format and/or SCI format indicator can be introduced. Whether such new format is supported within a COT for scheduling a group of UEs can be up to (pre-) configuration or an indicator in the COT information. Alternatively, within a COT, the scheduling or COT initiated UE can send multiple SCIs on the different sub-channels to the multiple UEs, in this case, the (potential) scheduled UEs or the UEs sharing the same COT should monitor SCI in the multiple sub-channels in addition to the first sub-channel. Whether the UEs sharing the COT or the (potential) scheduled UEs should monitor the multiple sub-channels or only the first sub-channel can be up to (pre-) configuration or an indicator in the COT information.

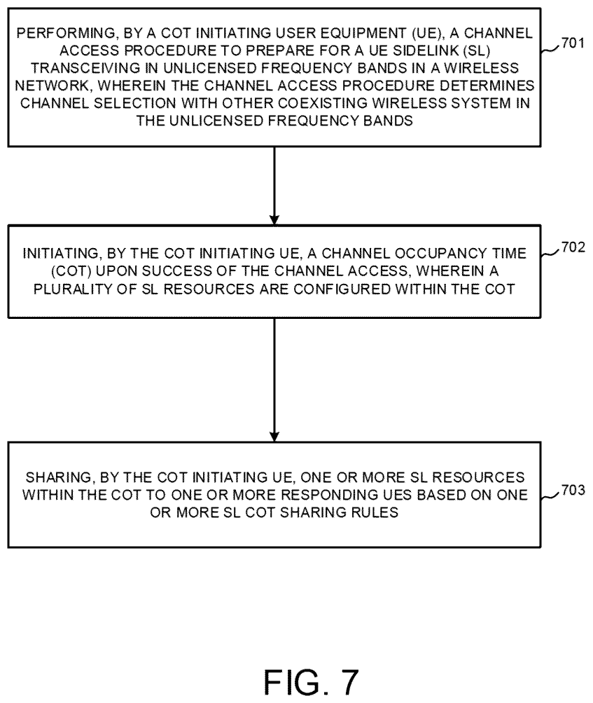

FIG. 7 illustrates an exemplary flow chart for the initiating UE for COT sharing in SL unlicensed communication system in accordance with embodiments of the current invention. At step 701, the COT initiating UE performs a channel access procedure to prepare for a UE sidelink (SL) transceiving in unlicensed frequency bands in a wireless network, wherein the channel access procedure determines channel selection with other coexisting wireless system in the unlicensed frequency bands. At step 702, the COT initiating UE initiates a COT upon success of the channel access, wherein a plurality of SL resources are configured within the COT. At step 703, the COT initiating UE shares one or more SL resources within the COT to one or more responding UEs based on one or more SL COT sharing rules.

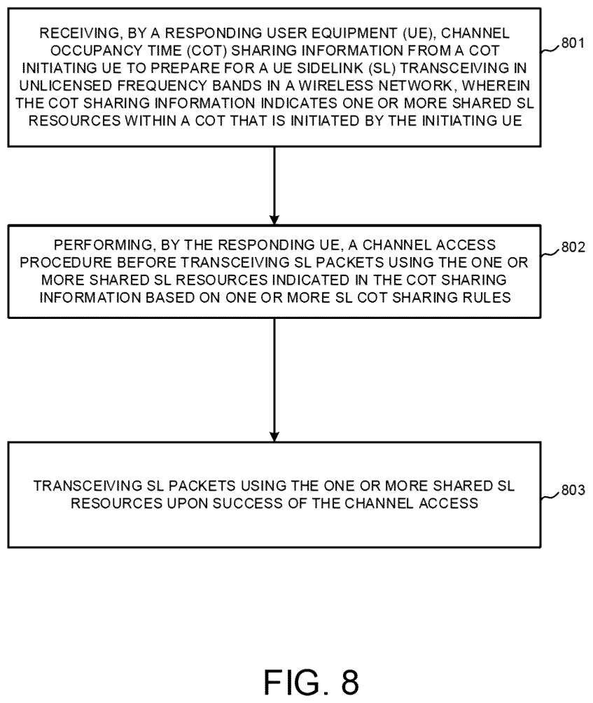

FIG. 8 illustrates an exemplary flow chart for the responding UE for COT sharing in SL unlicensed communication system in accordance with embodiments of the current invention. At step 801, the UE receives channel occupancy time (COT) sharing information from a COT initiating UE to prepare for a UE sidelink (SL) transceiving in unlicensed frequency bands in a wireless network, wherein the COT sharing information indicates one or more shared SL resources within a COT that is initiated by the COT initiating UE. At step 802, the UE performs a channel access procedure before transceiving SL packets using the one or more shared SL resources indicated in the COT sharing information based on one or more SL COT sharing rules. At step 803, the UE transceives SL packets using the one or more shared SL resources upon success of the channel access.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for channel occupancy time (COT) sharing, comprising:
performing, by a COT initiating user equipment (UE), a channel access procedure to prepare for a UE sidelink (SL) transceiving in unlicensed frequency bands in a wireless network, wherein the channel access procedure determines channel selection with other coexisting wireless system in the unlicensed frequency bands;
initiating, by the COT initiating UE, a channel occupancy time (COT) upon success of the channel access, wherein a plurality of SL resources are (pre-) configured within the COT; and
sharing, by the COT initiating UE, one or more SL resources within the COT to one or more responding UEs based on one or more SL COT sharing rules.

2. The method of claim 1, wherein the one or more SL resources are shared to a responding UE that is a target receiver of a SL transceiving from the COT initiating UE, and wherein the SL transceiving from the COT initiating UE uses at least one SL resource within the COT.

3. The method of claim 1, wherein the one or more SL resources are shared to a responding UE that uses the one or more SL resources for a SL transceiving, and wherein the COT initiating UE is a target receiver of the SL transceiving from the responding UE.

4. The method of claim 1, wherein the one or more SL resources are shared to a responding UE that uses the one or more SL resources to communicate with a second UE or the other UE(s).

5. The method of claim 1, COT sharing information is sent to a group of UEs that may share the one or more SL resources within the COT, wherein the COT sharing information includes sharing information, or scheduling information, or both sharing information and scheduling information.

6. The method of claim 5, COT sharing information are (pre-) configured to include one or more COT elements about the SL resources to be shared comprising COT time and frequency location information, shared COT starting offset information, remaining COT duration information, one or more resource block (RB) set(s) in the COT, channel access type, channel access priority type (CAPC) level, and ID information.

7. The method of claim 6, wherein the one or more RB sets in the COT comprises a plurality of sub-channels, and wherein physical sidelink control channel (PSCCH) locates in a lowest sub-channel of a lowest RB set of corresponding physical sidelink shared channel (PSSCH), or in the lowest sub-channel of every RB set of corresponding PSSCH.

8. The method of claim 5, wherein the COT sharing information is carried in a first stage sidelink control information (SCI), a second stage SCI, a combination of a first stage SCI and a second stage SCI or a MAC-CE, and the COT sharing information is carried in one or more formats comprising a new field in a first stage SCI, an existing field in a first stage SCI, a new field in a second stage SCI, and an existing field in a second stage SCI

9. The method of claim 1, further comprising sending, by the COT initiating UE, scheduling information to the one or more responding UEs.

10. A method, comprising:
receiving, by a responding user equipment (UE), channel occupancy time (COT) sharing information from a COT initiating UE to prepare for a UE sidelink (SL) transceiving in unlicensed frequency bands in a wireless network, wherein the COT sharing information indicates one or more shared SL resources within a COT that is initiated by the COT initiating UE;
performing, by the responding UE, a channel access procedure before transceiving SL packets using the one or more shared SL resources indicated in the COT sharing information based on one or more SL COT sharing rules; and
transceiving SL packets using the one or more shared SL resources upon success of the channel access.

11. The method of claim 10, wherein the COT sharing information includes one or more COT elements comprising COT time and frequency location information, shared COT starting offset information, remaining COT duration information, one or more resource block (RB) set(s) in the COT, channel access type, channel access priority type (CAPC) level, and ID information.

12. The method of claim 10, a channel access type is configured for the channel access to be performed by the responding UE.

13. The method of claim 12, wherein the channel access type is indicated via the COT sharing information, or (pre-) configured based on a transmission gap that is between a SL resource for transmission by the COT initiating UE and a starting position of the one or more shared SL resources to be used by the responding UE, or based on a transmission gap that is between a ending position of the one or more shared SL resources to be used by one responding UE and a starting position of the one or more shared SL resources to be used by another responding UE.

14. The method of claim 13, wherein a type 2A channel access is (pre-) configured if the transmission gap is greater than or equal to a first gap threshold, a type 2C channel access is (pre-) configured if the transmission gap is smaller than or equal to a second gap threshold, otherwise a type 2B channel access is (pre-) configured, and wherein the first gap threshold is greater than the second gap threshold.

15. A user equipment (UE), comprising:
a transceiver that transmits and receives radio frequency (RF) signal in a wireless network;
a channel access module that performs a channel access procedure to prepare for a UE sidelink (SL) transceiving in unlicensed frequency bands in the wireless network, wherein the channel access procedure determines channel selection with other coexisting wireless system in the unlicensed frequency bands;
a channel occupancy time (COT) module that initiates a COT upon success of the channel access, wherein a plurality of SL resources are (pre-) configured within the COT; and
a sharing module that shares one or more SL resources within the COT to one or more responding UEs based on one or more SL COT sharing rules.

16. The UE of claim 15, wherein one or more SL resources are shared to a responding UE that is a target receiver of a SL transceiving from the UE, and wherein the SL transceiving from the UE uses at least one SL resource within the COT.

17. The UE of claim 15, wherein one or more SL resources are shared to a responding UE that uses the one or more SL resources for a SL transceiving, and wherein the UE is a receiver of the SL transceiving.

18. The UE of claim 15, wherein one or more SL resources are shared to a responding UE that uses the one or more SL resources to communicate with a second UE or the other UE(s).

19. The UE of claim 15, COT sharing information is sent to a group of UEs that may share the one or more SL resources within the COT, and wherein COT sharing information are (pre-) configured to include one or more COT elements about the SL resources to be shared comprising COT time and frequency location information, shared COT starting offset information, remaining COT duration information, one or more resource block (RB) set(s) in the COT, channel access type, channel access priority type (CAPC) level, and ID information.

20. The UE of claim 15, wherein the COT sharing information is carried in a first stage sidelink channel information (SCI), a second stage SCI, a combination of a first stage SCI and a second stage SCI, or a MAC-CE.
